(19) United States
(12) Patent Application Publication
(10) Pub. No.: US 2018/0195333 A1
(43) Pub. Date: Jul. 12, 2018

(54) Bypass Apparatus and Doorbell Apparatus Using the Same

(71) Applicant: LG INNOTEK CO., LTD., Seoul (KR)

(72) Inventor: Ki Kyung JEON, Seoul (KR)

(21) Appl. No.: 15/866,090

(22) Filed: Jan. 9, 2018

(30) Foreign Application Priority Data
Jan. 9, 2017 (KR) 10-2017-0002978

(51) Int. Cl. E05F 15/60; G08B 3/10

(52) U.S. Cl. CPC E05F 15/60; G08B 3/10

(57) ABSTRACT

According to one embodiment of the present disclosure, a bypass apparatus includes a current detector for detecting an input current; a first switch device which is turned on when a current detected in the current detector is lower than a reference current, and turned off when the detected current is equal to or higher than the reference current; and a second switch device which connects in parallel with the first switch device, is turned off when the detected current is lower than the reference current, and turned on when the detected current is equal to or higher than the reference current, wherein between the first switch device and the second switch device is connected a chime bell, and between the current detector and the first switch device is connected a load.

### CROSS-REFERENCE TO RELATED APPLICATION

This application claims the benefit under 35 U.S.C. § 119 of Korean Patent Application No. 10-2017-0002978, filed Jan. 9, 2017, the disclosure of which is herein incorporated by reference in its entirety.

### BACKGROUND

### 1. Field of the Invention

The present disclosure relates to a bypass apparatus and a doorbell apparatus using the same.

### 2. Discussion of Related Art

A conventional in-house doorbell system includes a transformer, a doorbell, and a doorbell switch.

FIGS. 1 and 2 illustrate examples of the doorbell system.

Referring to FIGS. 1 and 2, a transformer 10 may include a primary coil and a secondary coil. The primary coil may be connected to an in-house AC power (not shown), and the secondary coil may be connected in series to a chime bell 12 and a doorbell button 14 or 16. The transformer 10 transforms an AC voltage to have a level suitable for driving the chime bell. The chime bell 12 is a device for outputting a sound using electromagnetism or electricity, and may be used together with a bell, a buzzer, a chime, a doorbell, or the like. Further, the doorbell button 14 or 16 is usually an open switch. When the doorbell button becomes a closed switch, the doorbell system is activated. The doorbell button 14 or 16 may be used together with a button, a doorbell switch, or the like. For example, when a person presses the doorbell button 14 or 16, the doorbell button 14 or 16 becomes the closed switch, thereby forming a closed circuit for the chime bell 12. Therefore, a high current flows in a coiled wire provided in the chime bell 12, thereby making the coiled wire act as an electromagnet. Inside the coiled wire, there is a pestle, and the magnetized coiled wire pulls the pestle to make a sound.

As shown in FIG. 1, in case of a single door system, the doorbell system 10 may include one doorbell button 14. In case of a two door system, the doorbell system 10 may include two doorbell buttons 14 and 16.

Meanwhile, with increased needs for user convenience, a technology for connection between the doorbell button and various interface devices has been developed. To this end, there has been an attempt to make power diverge from the conventional doorbell system and supply the diverged power to the interface devices. In this case, an electric current flowing in the interface device has an influence on the chime bell, thereby causing a malfunction or noise in the chime bell.

### SUMMARY OF THE INVENTION

The present disclosure is directed to providing a bypass apparatus and a doorbell apparatus using the same.

According to one embodiment of the present disclosure, there is provided a bypass apparatus including a current detector for detecting an input current; a first switch device which is turned on when a current detected in the current detector is lower than a reference current, and turned off when the detected current is equal to or higher than the reference current; and a second switch device which connects in parallel with the first switch device, is turned off when the detected current is lower than the reference current, and turned on when the detected current is equal to or higher than the reference current, wherein between the first switch device and the second switch device is connected a chime bell, and between the current detector and the first switch device is connected a load.

The current detector may include a first end connected to the load, and a second end connected to a power supply, and the first switch device may include a first end connected to the load, and a second end connected to the power supply.

According to one embodiment of the present disclosure, there is provided a bypass apparatus for controlling power supplied to a chime bell in accordance with operations of a doorbell apparatus, the bypass apparatus including: a first connection terminal and a second connection terminal to which alternating current (AC) power is received from a transformer; a rectifier which is connected to the first connection terminal and the second connection terminal, and rectifies the AC power into direct current (DC) power to supply operation power; a current detector for detecting an input current flowing from the first connection terminal to the doorbell apparatus; a first switch device which is turned on when a current detected in the current detector is lower than a reference current, and turned off when the detected current is equal to or higher than the reference current; and a second switch device which is turned off when the detected current is lower than the reference current, and turned on when the detected current is equal to or higher than the reference current, wherein the doorbell apparatus, the first connection terminal, the first switch device and the second connection terminal are configured to form a first closed loop when the first switch device is turned on, and the doorbell apparatus, the chime bell, the first connection terminal, the second switch device, and the second connection terminal are configured to form a second closed loop when the second switch device is turned on.

The bypass apparatus may further include a third connection terminal and a fourth connection terminal which output the AC power to the doorbell apparatus, wherein the third connection terminal may be connected to the first connection terminal, the fourth connection terminal may be connected to a first end of the first switch device and a first end of the second switch device, and the first switch device may include a second end connected to the second connection terminal, and the second switch device may include a second end connected to the second connection terminal.

The bypass apparatus may further include a comparator which compares the detected current and the reference current.

The bypass apparatus may further include a timing controller which is connected to each of the first switch device and the second switch device, generates a control signal for controlling the first switch device and the second switch device, and maintains a turn-off state of the first switch device and a turn-on state of the second switch device for a preset state maintenance time, wherein the timing controller may include a first end connected to the comparator.

The timing controller may include a resistor and a capacitor, and the preset state maintenance time may be determined based on a ratio of resistance of the resistor to capacitance of the capacitor.

The first switch device may include a gate terminal connected to a first output terminal of the timing controller, the second switch device may include a gate terminal connected to a second output terminal of the timing controller, and the first output terminal and the second output terminal may be different in an output value from each other.

The operation states of the doorbell apparatus may include a first state where a doorbell button is pressed, and a second state where the doorbell button is not pressed, and an input current in the first state may be greater than an input current in the second state.

According to one embodiment of the present disclosure, there is provided a bypass method of controlling power supplied to a chime bell in accordance with operation states of a doorbell apparatus, the bypass method including: detecting a current to detect an input current flowing from a transformer to the doorbell apparatus; turning on a first switch device and turning off a second switch device when the current detected in the detecting of the current is lower than a reference current, and turning off the first switch device and turning on the second switch device when the current detected in the detecting of the current is equal to or higher than the reference current; forming a first closed loop with the transformer, the doorbell apparatus, and the first switch device when the first switch device is turned on; and forming a second closed loop with the transformer, the doorbell apparatus, the chime bell, and the second switch device when the second switch device is turned on.

The input current may flow to the doorbell apparatus without passing through the chime bell when the first closed loop is formed, and the input current may flow to the doorbell apparatus after passing through the chime bell when the second closed loop is formed.

The bypass method may further include, by a timing controller, generating a control signal for controlling the first switch device to be turned on or off and the second switch device to be turned on or off in accordance with results of comparison between the detected current and the reference current.

The timing controller may set in advance a time, for which a turn-off state of the first switch device is maintained and a turn-on state of the second switch device is maintained.

### BRIEF DESCRIPTION OF THE DRAWINGS

FIGS. 1 and 2 illustrate examples of a doorbell system.

FIG. 3 is a schematic view of a doorbell system according to one embodiment of the present disclosure.

FIG. 4 is a block diagram of an interface according to one embodiment of the present disclosure.

FIG. 5 is a block diagram of a doorbell system according to one embodiment of the present disclosure.

FIGS. 6(a) and 6(b) show examples of materializing a bypass apparatus in the doorbell system of FIG. 5.

FIG. 7 shows another example of materializing a bypass apparatus in the doorbell system of FIG. 5.

FIG. 8 is a block diagram of a doorbell system according to another embodiment of the present disclosure.

FIG. 9 shows an example of materializing a bypass apparatus in the doorbell system of FIG. 8.

FIG. 10 shows another example of materializing a bypass apparatus in the doorbell system of FIG. 8.

FIG. 11 is a circuit diagram of the bypass apparatus according to one embodiment of the present disclosure.

FIG. 12 is a timing diagram of a timing controller included in the bypass apparatus of FIG. 11.

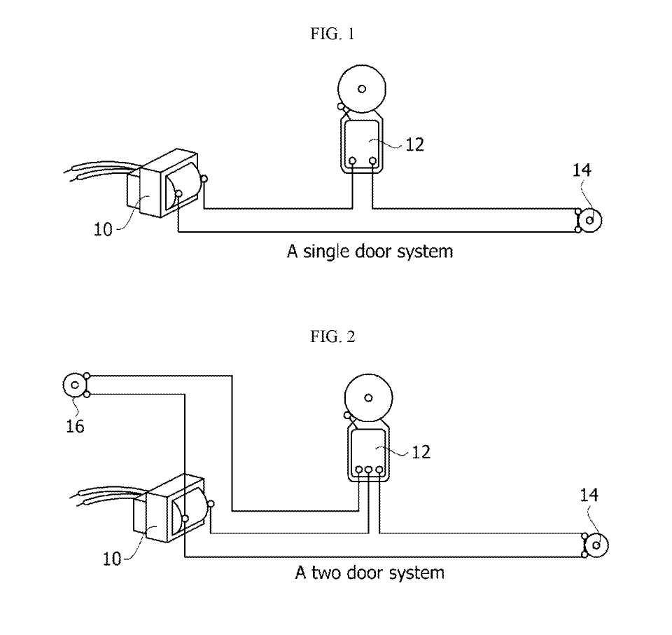

### DETAILED DESCRIPTION OF THE EMBODIMENTS

The present disclosure allows various changes and has many embodiments, and thus exemplary embodiments will be illustrated in the accompanying drawings and described. However, it will be appreciated that the present disclosure is not limited to the exemplary embodiments, and all modifications, equivalents and substitutes may be made without departing from the idea and technical scope of the present disclosure.

It will be understood that, although terms first, second, etc. may be used herein to describe various elements, the elements should not be limited by the terms. The terms are only used to distinguish one element from another. For example, a first element could be termed a second element, and, similarly, a second element could be termed a first element, without departing from the scope of the present disclosure. As used here, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, embodiments will be described in detail with reference to the accompanying drawings, in which like numerals refer to like elements throughout, and repetitive descriptions will be omitted.

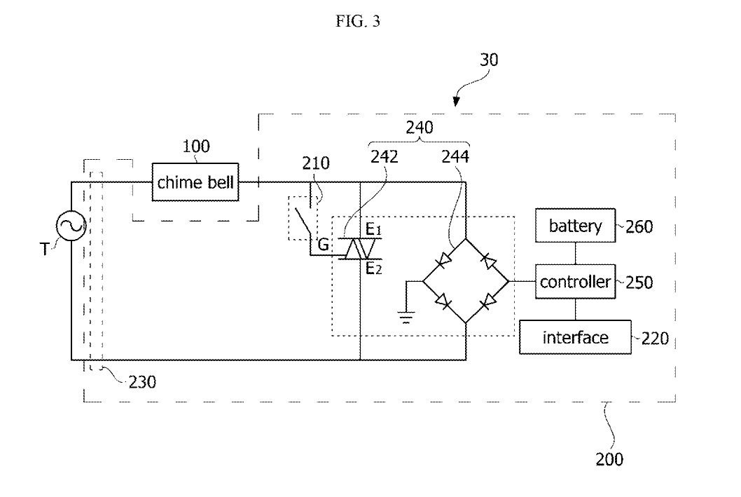

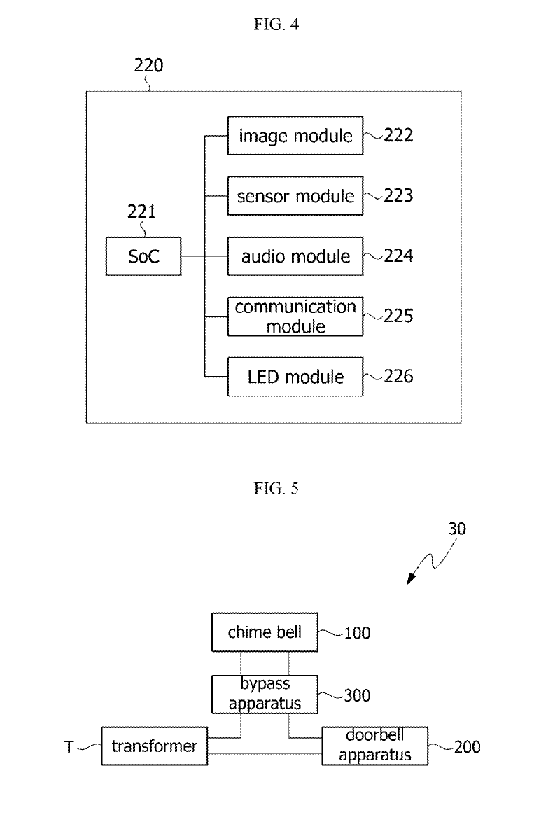

FIG. 3 is a schematic view of a doorbell system according to one embodiment of the present disclosure, and FIG. 4 is a block diagram of an interface according to one embodiment of the present disclosure.

Referring to FIG. 3, a doorbell system 30 includes a chime bell 100 and a doorbell apparatus 200.

The chime bell 100 is a device for outputting a sound using electromagnetism or electricity, and may be used together with a bell, a buzzer, a chime, a doorbell, or the like. The chime bell 100 may be a mechanical doorbell that outputs a short sound made with a pestle, or an electronic doorbell that outputs a melody.

The doorbell apparatus 200 includes a doorbell button 210 and an interface 220.

The doorbell button 210 may be used together with a button, a doorbell switch, etc. The doorbell apparatus 200 may be placed around a door.

The interface 220 may include, as shown in FIG. 4, a system on chip (SoC) 221, an image module 222, a sensor module 223, an audio module 224, a communication module 225, and a light emitting diode (LED) module 226. However, these elements are merely given as an example, and the interface 220 according to one embodiment of the present disclosure may include elements more or less than these elements.

The SoC 221 is connected to the image module 222, the sensor module 223, the audio module 224, the communication module 225, and the LED module 226, and may generally control the interface 220. For example, the SoC 221 may control the modules included in the interface 220 to be enabled or disabled.

The image module 222 may include a camera unit. The camera unit may include a lens and an image sensor. The lens includes at least one of a convex lens, a concave lens, a cylinder lens, a Fresnel Lens, and a wide-angle lens, and takes an image of an object within a certain range from an installed position. The image sensor converts an optical signal incident through the lens into an image signal. The image sensor is an element generally used in a digital camera or the like, and serves to convert light incident on the camera lens, i.e. taken image information into an electric signal, i.e. digital information.

The sensor module 223 senses a surrounding object. The sensor module 223 may for example include at least one of a geomagnetic sensor, an acceleration sensor, an altimeter, a gyro sensor, an infrared sensor, and a proximity sensor. Here, the infrared sensor may include a passive infrared ray (PIR) sensor. The PIR sensor may sense a temperature change of an object. Accordingly, when a person moves, the sensor module 223 may sense presence of the person based on the temperature change. The sensor module 223 may be installed around the image module 222, and may be provided in plural.

The SoC 221 receives an image signal through the image module 222, and a sensed signal of an object through the sensor module 223, and processes the received signals. For example, the SoC 221 may correct the image signal received through the image module 222 with the sensed signal of an object received through the sensor module 223.

The audio module 224 may include a microphone and a loudspeaker. The microphone may receive an audio signal, and the loudspeaker may output an audio signal. The SoC 221 may process an audio signal received through the microphone.

The communication module 225 includes a wired or wireless communication module. and transmits an image signal processed through the SoC 221 to a display device (not shown) or an audio signal processed though the SoC 221 to the loudspeaker.

The LED module 226 is a light emitting module and may be used together with a flash LED.

The interface 220 may be used together with a network camera or a camera device.

As the doorbell button 210 is turned on or off, electric power input from a transformer T may be supplied to only the chime bell 100 or may be supplied to the interface 220 via the chime bell 100.

To this end, the doorbell apparatus 200 may further include a power input 230, a switching circuit 240, a controller 250 and a battery 260. In this embodiment, the transformer T may refer to not only an in-house transformer, but also a power supply connected to the in-house transformer and supplying power to the doorbell system 30.

Through the power input 230, alternating current (AC) power is supplied to the doorbell apparatus 200.

The switching circuit 240 is connected to the doorbell button 210 and may include a triac device 242. The triac device 242 is a semiconductor control part, in which bi-directional current control is performed, including two main electrodes E1 and E2 and one gate electrode G When there are no gate signals applied to the gate electrode G, the triac device 242 is turned off. When a gate signal is applied to the gate electrode G, the triac device 242 is turned on bi-directionally regardless of the polarities of the main electrodes E1 and E2.

When the doorbell button 210 is pressed, i.e. when the doorbell button 210 is turned on, the gate signal is applied to the gate electrode G of the triac device 242, thereby forming a closed circuit of passing through the power input 230, the chime bell 100 and the triac device 242 and returning to the power input 230. That is, a current flows via the chime bell 100 in a direction to turn on the triac device 242, but is cut off not to flow in the doorbell apparatus 200, i.e. not to flow toward the controller 250. Since the current does not flow toward the controller 250, power needed for the interface 220 may be supplied from the battery 260.

Meanwhile, when the doorbell button 210 is released from the pressed state, i.e. when the doorbell button 210 is turned off, the current flows in the doorbell apparatus 200, i.e. toward the controller 250 via the chime bell 100. To this end, the switching circuit 240 may further include a rectifier 244. The rectifier 244 is connected to the controller 250, rectifies an AC supplied from the power input 230 into a direct current (DC), and supplies the DC to the controller 250. In this case, the rectifier 244 may for example include a bridge diode. The bridge diode refers to a bridge circuit connecting four diodes. The bridge diode rectifies the AC into the DC and outputs the DC.

The controller 250 receives the DC rectified by the rectifier 244. The controller 250 may include a converter and a battery charging chip. The converter may serve to drop a DC voltage output through the rectifier 244 into a voltage for the battery charging chip. Here, the converter may be a DC-DC converter. For example, the converter may drop a voltage of 8 to 24 V into a voltage of 5 V.

The battery charging chip is connected to the converter, and receives a predetermined voltage from the converter. The battery charging chip may control to supply power to the interface 220, or charge the battery 260 with the power. The battery charging chip may control the battery 260 to supply charged power to the interface 220. The battery charging chip may be used together with a battery management integrated circuit (BMIC).

Meanwhile, when the current flows in the doorbell apparatus 200 via the chime bell 100 in case where the doorbell button 210 is turned off, an overcurrent flows in the chime bell 100 and thus the chime bell 100 may malfunction. The doorbell apparatus 200 requires higher power as it has higher performance, and thus a malfunction problem of the chime bell 100 becomes more serious. To solve this problem, a bypass apparatus is additionally provided according to one embodiment of the present invention.

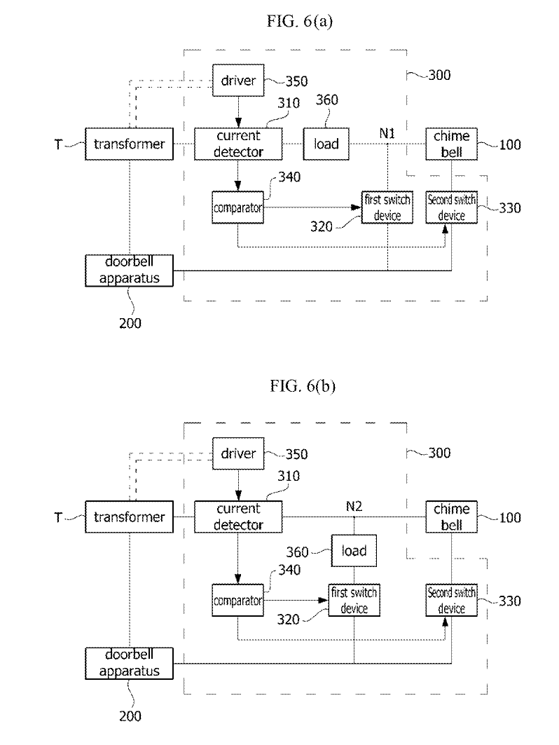

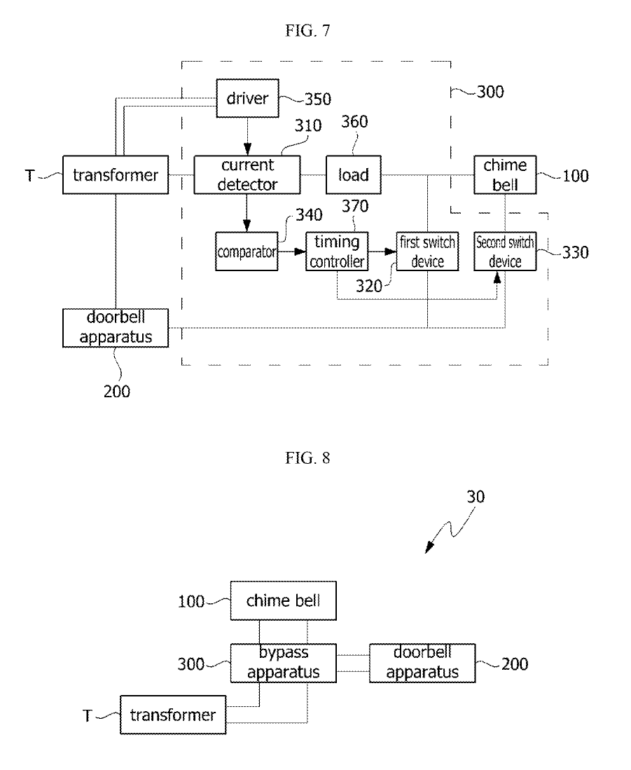

FIG. 5 is a block diagram of a doorbell system according to one embodiment of the present disclosure, FIGS. 6(a) and 6(b) show an example of materializing a bypass apparatus in the doorbell system of FIG. 5, and FIG. 7 shows another example of materializing a bypass apparatus in the doorbell system of FIG. 5.

Referring to FIG. 5, the doorbell system 30 includes the chime bell 100 and the doorbell apparatus 200. Both ends of the transformer T are connected to the chime bell 100 and the doorbell apparatus 200, and both ends of the chime bell 100 are connected to the transformer T and the doorbell apparatus 200, and both ends of the doorbell apparatus 200 are connected to the chime bell 100 and the transformer T. Further, the doorbell system 30 according to the embodiment of the present disclosure additionally includes a bypass apparatus 300, and the bypass apparatus 300 may be connected in parallel to both ends of the chime bell 100.

Thus, when the doorbell button 210 is turned off, the current flowing from the transformer T toward the doorbell apparatus 200 is bypassed via the bypass apparatus 300, and it is thus possible to inhibit an overcurrent from flowing through the chime bell 100, thereby inhibiting the chime bell 100 from malfunctioning.

In more detail, referring to FIGS. 6(a) and 6(b), the bypass apparatus 300 includes a current detector 310, a first switch device 320, a second switch device 330, a comparator 340, a driver 350, and a load 360.

Here, the chime bell 100 is connected between the first switch device 320 and the second switch device 330, and the load 360 is connected between the current detector 310 and the first switch device 320. Further, a first end of the current detector 310 is connected to the load 360, and a second end of the current detector 310 is connected to the transformer T. A first end of the first switch device 320 is connected to the load 360, and a second end of the first switch device 320 is connected to the transformer T via the doorbell apparatus 200.

According to one embodiment of the present disclosure, the current detector 310 detects an input current input to the doorbell system 30. Operation states of the doorbell apparatus 200 includes a first state in which the doorbell button is pressed, and a second state in which the doorbell button is not pressed. The interface 220, e.g. the camera module or the like, included in the doorbell apparatus 200 is turned on in the first state, and the doorbell apparatus 200 is on standby in the second state. The input current in the first state, may be greater than the input current in the second state.

That is, when the doorbell button 210 is pressed, the maximum current allowable in the transformer T may be input to the doorbell system 30.

The first switch device 320 may be set to be turned on when a current detected in the current detector 310 is lower than a reference current, and turned off when the detected current is equal to or higher than the reference current. Further, the second switch device 330 is connected in parallel to the first switch device 320, and may be set to be turned off when the current detected in the current detector 310 is lower than the reference current and turned on when the detected current is equal to or higher than the reference current.

Accordingly, when the doorbell button 210 is not pressed, the current detected in the current detector 310 is lower than the reference current, and thus the first switch device 320 is turned on and the second switch device 330 is turned off, thereby making the current input to the doorbell system 30 flow toward only the doorbell apparatus 200 without passing through the chime bell 100. On the other hand, when the doorbell button 210 is pressed, the current detected in the current detector 310 is higher than the reference current, and thus the first switch device 320 is turned off and the second switch device 330 is turned on, thereby making the current input to the doorbell system 30 flow to the doorbell apparatus 200 after passing through the chime bell 100.

For example, in case of a transformer of 10 VA/16 Vac, let the current for operating the doorbell apparatus 200 be 300 mA, and the reference current be 350 mA. In the state that the doorbell button 210 is not pressed, a current of 300 mA for operating the doorbell apparatus 200 flows in the doorbell system 30. In this state, since the current detector 310 detects the current of 300 mA lower than the reference current, the first switch device 320 is turned on and the second switch device 330 is turned off. On the other hand, when the doorbell button 210 is pressed, the maximum current, i.e. 600 mA allowable in the transformer T may be input to the doorbell system 30. In this case, since the current detector 310 detects the current higher than the reference current of 350 mA, the first switch device 320 is turned off and the second switch device 330 is turned on.

In this case, the comparator 340 may compare the current detected by the current detector 310 and the reference current. Alternatively, the comparator 340 may compare a voltage converted from the current detected by the current detector 310 and a reference voltage. In accordance with a comparison result, the comparator 340 may control turning on and/or off the first switch device 320 and the second switch device 330.

In addition, according to one embodiment of the present disclosure, the current detector 310 and the comparator 340 may be driven by the driver 350. The driver 350 may convert AC power received from the transformer T into DC power, and changes the DC power to have a voltage, e.g. 3.3 V for driving the current detector 310 and the comparator 340. However, the driver 350 is connected to form a closed loop with the transformer T, and it is therefore difficult to supply enough power to the driver 350 when the first switch device 320 is turned on. To solve this, according to one embodiment of the present disclosure, the load 360 is additionally connected between the current detector 310 and the first switch device 320. The load 360 may be connected between the current detector 310 and a node N1 where the first end of the first switch device 320 meets a first end of the chime bell 100 as shown in FIG. 6(a), or may be connected between the first end of the first switch device 320 and a node N2 where the current detector 310 meets the chime bell 100 as shown in FIG. 6(b). Thus, even when the first switch device 320 is turned on, there is a resistor in a closed loop from the transformer T toward the first switch device 320, so that the transformer T can supply power to the closed loop of the driver 350. With this, the driver 350 can secure a driving voltage for driving the current detector 310 and the comparator 340. Here, the resistance of the load 360 may correspond to the resistor of the chime bell 100.

Meanwhile, the bypass apparatus 300 according to one embodiment of the present disclosure may further include a timing controller 370.

Referring to FIG. 7, the timing controller 370 has a first end connected to the comparator 340, and a second end connected to the first switch device 320 and the second switch device 330. Further, the timing controller 370 may control a turn-off time of the first switch device 320 and a turn-on time of the second switch device 330. Thus, it is possible to control a time for which the chime bell 100 outputs a sound. For example, when the chime bell 100 is an electronic chime bell that outputs a melody, the second switch device 330 needs to be turned on while the chime bell 100 outputs the melody. Therefore, the time for which the second switch device 330 is turned on needs to be longer than a time for which the doorbell button 210 is actually pressed.

Like this, various chime bells 100 are available since the timing controller 370 controls the turn-off time of the first switch device 320 and the turn-on time of the second switch device 330.

Here, the timing controller 370 may control the turn-off time of the first switch device 320 and the turn-on time of the second switch device 330 for a preset time. The preset time may be for example controlled in accordance with resistance of a resistor and capacitance of a capacitor provided in the timing controller 370.

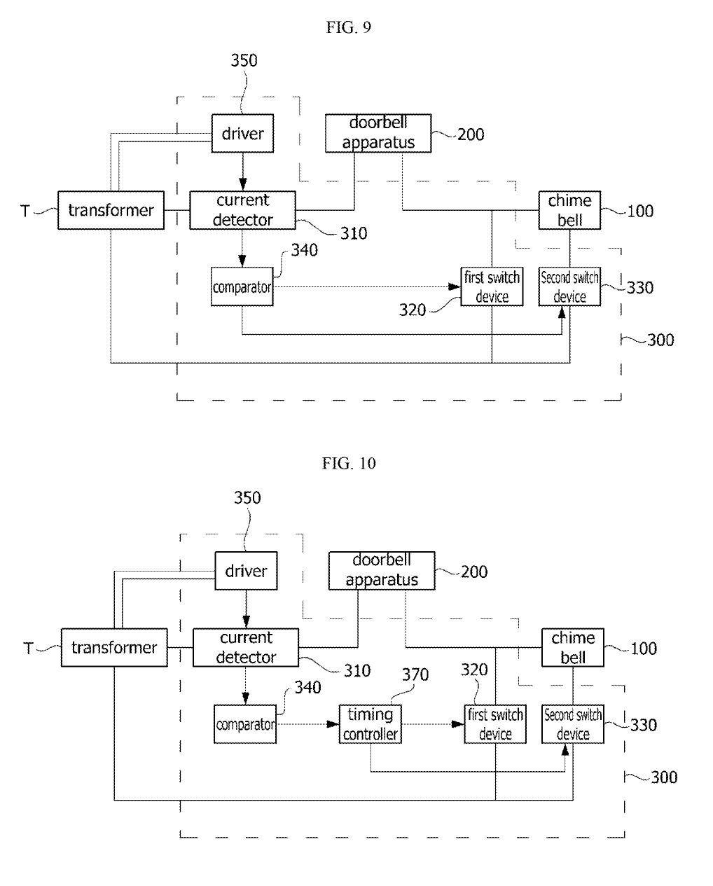

FIG. 8 is a block diagram of a doorbell system according to another embodiment of the present disclosure, FIG. 9 shows an example of materializing a bypass apparatus in the doorbell system of FIG. 8, and FIG. 10 shows another example of materializing a bypass apparatus in the doorbell system of FIG. 8. Repetitive descriptions to those of FIGS. 5 to 7 will be omitted.

Referring to FIG. 8, the doorbell system 30 includes the chime bell 100, the doorbell apparatus 200, and the bypass apparatus 300. Both ends of the transformer T may be connected to both ends of the chime bell 100, and the bypass apparatus 300 may be connected in parallel to both ends of the chime bell 100 between both ends of the transformer T and both ends of the chime bell 100. Further, the doorbell apparatus 200 may be connected to the bypass apparatus 300.

Therefore, when the doorbell button 210 is turned off, a current flowing from the transformer T toward the doorbell apparatus 200 is bypassed toward the bypass apparatus 300, and thus an overcurrent does not flow through the chime bell 100, thereby inhibiting the chime bell 100 from malfunctioning.

In more detail, referring to FIG. 9, the bypass apparatus 300 includes the current detector 310, the first switch device 320, the second switch device 330, the comparator 340, and the driver 350. According to one embodiment of the present disclosure, the load 360 described in the embodiment shown in FIGS. 5 to 7 may be replaced with the doorbell apparatus 200.

That is, the chime bell 100 is connected between the first switch device 320 and the second switch device 330, and the doorbell apparatus 200 is connected between the current detector 310 and the first switch device 320. Further, the current detector 310 has the first end connected to the doorbell apparatus 200, and the second end connected to the transformer T. Further, the first switch device 320 has the first end connected to the doorbell apparatus 200, and the second end connected to the transformer T.

Thus, the doorbell apparatus 200 can serve as the load 360 described in the embodiment shown in FIGS. 5 to 7. Since there is a resistor in the closed loop from the transformer T toward the first switch device 320 even when the first switch device 320 is turned on, the transformer T may also supply power to the closed loop of the driver 350. In result, the driver 350 can secure a driving voltage for driving the current detector 310 and the comparator 340.

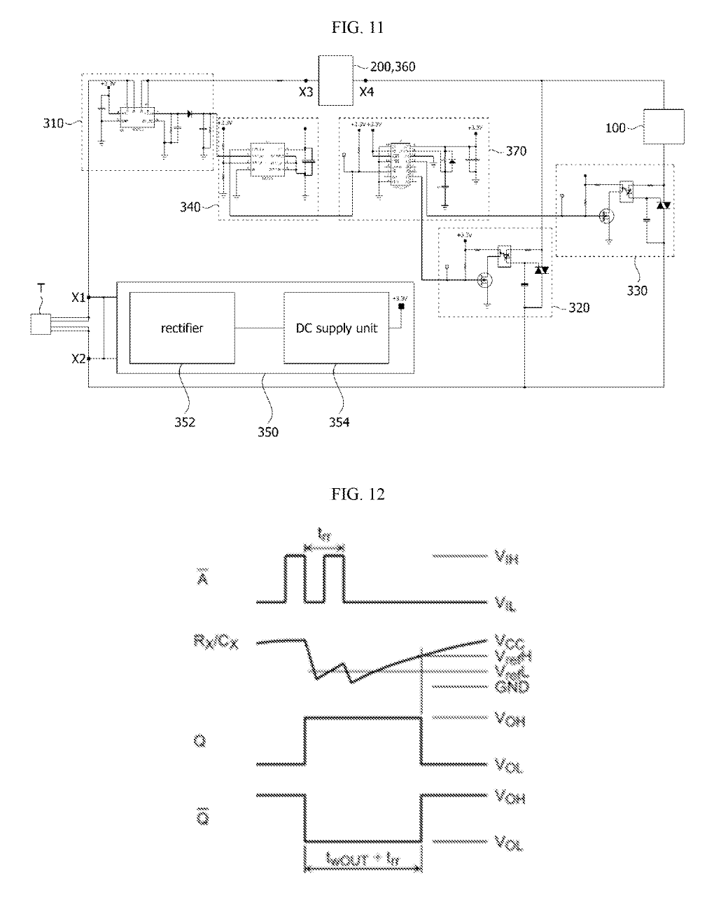

FIG. 11 is a circuit diagram of the bypass apparatus according to one embodiment of the present disclosure, and FIG. 12 is a timing diagram of a timing controller included in the bypass apparatus of FIG. 11.

Referring to FIG. 11, the driver 350 is connected to the transformer T and forms a closed circuit with the transformer T. The driver 350 includes a rectifier 352 and a DC supplying unit 354. To this end, the bypass apparatus includes a first connection terminal X1 and a second connection terminal X2 to which AC power is supplied from the transformer T, and the rectifier 352 of the driver 350 may be connected to the first connection terminal X1 and the second connection terminal X2. The rectifier 352 may include a bridge diode, and converts AC power received from the transformer T into DC power. Further, the DC supplying unit 354 may change the DC power rectified by the rectifier 352 into a voltage, e.g. 3.3 V for driving the current detector 310, the first switch device 320, the second switch device 330, the comparator 340, the timing controller 370, and the like.

To stably supply power from the transformer T to the driver 350 even when the doorbell button 210 is not pressed, i.e. even when the doorbell apparatus 200 is operating, the load 360 or the doorbell apparatus 200 may be connected as a resistor between the current detector 310 and the first switch device 320. To this end, the bypass apparatus may further include a third connection terminal X3 and a fourth connection terminal X4 to output AC power to the load 360 or the doorbell apparatus 200. The third connection terminal X3 may connect with the first connection terminal X1, and the fourth connection terminal X4 may connect with the first end of the first switch device 320 and a first end of the second switch device 330.

Meanwhile, the current detector 310 is driven by voltage supplied from the driver 350, and detects the input current flowing from the first connection terminal X1 connected to the transformer T to the doorbell apparatus 200. The first switch device 320 is turned on when the current detected in the current detector 310 is lower than the reference current, and turned off when the detected current is equal to or higher than the reference current. Further, the second switch device 330 is turned off when the current detected in the current detector 310 is lower than the reference current, and turned on when the detected current is equal to or higher than the reference current. In this case, the second end of the first switch device 320 may be connected to the second connection terminal X2, and a second end of the second switch device 330 may be connected to the second connection terminal X2.

Therefore, the doorbell apparatus 200, the first connection terminal X1, the first switch device 320 and the second connection terminal X2 form a first closed loop when the first switch device 320 is turned on. Further, the doorbell apparatus 200, the chime bell 100, the first connection terminal X1, the second switch device 330 and the second connection terminal X2 form a second closed loop when the second switch device 330 is turned on.

An output terminal VIout of the current detector 310 may connect with an input terminal Input_A(−) of the comparator 340. In this case, a device for converting the detected current into a voltage may be connected between the output terminal VIout of the current detector 310 and the input terminal Input_A(−) of the comparator 340. Meanwhile, the comparator 340 further includes an input terminal Input_A(+) to which the reference current or the reference voltage is input, and compares an input value of the input terminal Input_A(−) and an input value of the input terminal Input_A(+).

An output terminal Output_A of the comparator 340 may connect with an input terminal 1Ā of the timing controller 370. When an input value of the input terminal Input_A(−) is less than an input value of the input terminal Input_A(+), i.e. when the detected current is less than the reference current as the doorbell button 210 is not pressed, the output terminal Output_A of the comparator 340 outputs 0. Thus, an inversed value of 1 may be input to the input terminal 1Ā of the timing controller 370. On the other hand, when an input value of the input terminal Input_A(−) is greater than an input value of the input terminal Input_A(+), i.e. when the detected current is greater than the reference current as the doorbell button 210 is pressed, the output terminal Output_A of the comparator 340 outputs 1. Thus, an inversed value of 0 may be input to the input terminal 1Ā of the timing controller 370. The timing controller 370 may generate a control signal for controlling the first switch device 320 and the second switch device 330 in response to a value input to the input terminal Referring to the timing diagram of FIG. 12, at the moment when a value input to the input terminal 1Ā of the timing controller 370 is changed from 1 to 0, an output terminal Q̅ connected to a gate terminal of the first switch device 320 outputs 0, and an output terminal Q connected to a gate terminal of the second switch device 330 outputs 1. Therefore, the first switch device 320 is turned off, and the second switch device 330 is turned on, thereby making a current input to the doorbell system 30 flow toward the chime bell 100.

In this case, even though a value input to the input terminal 1Ā of the timing controller 370 is changed from 0 to 1 again as the doorbell button 210 becomes open, a time, for which the output terminal Q̅ connected to the gate terminal of the first switch device 320 outputs 0 and the output terminal Q connected to the gate terminal of the second switch device 330 outputs 1, can be maintained for t_{wout}. Thus, even though the doorbell button 210 is momentarily pressed and open again, the turn-off state of the first switch device 320 and the turn-on state of the second switch device 330 can be maintained for a preset state maintenance time, thereby allowing the chime bell 100 to output a melody for a predetermined period of time.

In this case, as shown in FIG. 12, the time, for which the output terminal Q̅ connected to the gate terminal of the first switch device 320 outputs 0 and the output terminal Q connected to the gate terminal of the second switch device 330 outputs 1, may be varied depending a ratio (Rx/Cx) of resistance Rx of the resistor to capacitance Cx of the capacitor included in the timing controller 370. That is, the time, for which the output terminal Q̅ connected to the gate terminal of the first switch device 320 outputs 0 and the output terminal Q connected to the gate terminal of the second switch device 330 outputs 1, may last until the ratio (Rx/Cx) of the resistance Rx to the capacitance Cx exceeds V_{ref}H. Therefore, by adjusting the ratio (Rx/Cx) of the resistance Rx of the resistor to the capacitance Cx of the capacitor included in the timing controller 370, it is possible to control the time for which a current flows in the chime bell 100, i.e. the state maintenance time for maintaining the turn-off state of the first switch device 320 and the turn-on state of the second switch device 330.

Here, each of the first switch device 320 and the second switch device 330 may include a triac device. Alternatively, the first switch device 320 and the second switch device 330 may each further include a transistor and a photo-triac device.

When the output terminal of the timing controller 370 outputs 1 and the output terminal Q outputs 0, 1 is input to the gate terminal of the first switch device 320 and 0 is input to the gate terminal of the second switch device 330. Thus, the first switch device 320 is turned on and the second switch device 330 is turned off, thereby allowing a current to flow in the doorbell apparatus 200. On the other hand, when the output terminal Q̅ of the timing controller 370 outputs 0 and the output terminal Q outputs 1, 0 is input to the gate terminal of the first switch device 320 and 1 is input to the gate terminal of the second switch device 330. Thus, the first switch device 320 is turned off and the second switch device 330 is turned on, thereby allowing a current to flow in the doorbell apparatus 200.

Like this, according to one embodiment of the present disclosure, the path of the current may be bypassed through the bypass apparatus 300 in accordance with whether the doorbell button 210 is pressed or not, thereby inhibiting the chime bell 100 from malfunctioning as an overvoltage is applied to the chime bell 100.

Further, it is possible to set the reference value of the comparator 340 in accordance with the specifications of the doorbell apparatus 200 and in-house environments, and thus it is applicable to various conditions.

In addition, a current can be supplied to the chime bell 100 for a predetermined period of time even though the doorbell button 210 is pressed and momentarily opened, and it is thus applicable to an electronic chime bell that outputs a melody. Besides, it is also possible to freely set a time for supplying a current to the chime bell 100 by adjusting the ratio Rx/Cx of the timing controller 370.

According to one embodiment of the present disclosure, the doorbell system can stably supply power to the interface device. In particular, according to one embodiment of the present disclosure, the path of the current flowing toward the chime bell can be bypassed as the doorbell button is turned on/off. Therefore, it is possible to inhibit the malfunction problem of the chime bell due to the current flowing toward the interface device even when the doorbell button is turned off, and it is also possible to stably output the sound of the chime bell by cutting off the path of the current flowing toward the interface device when the doorbell button is turned on.

Although exemplary embodiments have been illustrated and described, it will be understood by those skilled in the art that various modification and changes may be made in the embodiments without departing from the idea and scope of the present inventive concept, which are defined in the appended claims and their equivalents.

What is claimed is:

1. A bypass apparatus comprising:
a current detector for detecting an input current;
a first switch device that is turned on when a current detected in the current detector is lower than a reference current, and is turned off when the detected current is equal to or higher than the reference current; and
a second switch device that connects in parallel with the first switch device, is turned off when the detected current is lower than the reference current, and is turned on when the detected current is equal to or higher than the reference current, wherein
a chime bell is connected between the first switch device and the second switch device, and
a load is connected between the current detector and the first switch device.

2. The bypass apparatus of claim 1, wherein the current detector comprises a first end connected to the load, and a second end connected to a power supply; and
the first switch device comprises a first end connected to the load, and a second end connected to the power supply.

3. The bypass apparatus of claim 1, further comprising a comparator which compares the detected current and the reference current.

4. The bypass apparatus of claim 3, further comprising a timing controller that is connected to each of the first switch device and the second switch device, generates a control signal for controlling the first switch device and the second switch device, and maintains a turn-off state of the first switch device and a turn-on state of the second switch device for a preset state maintenance time;
wherein the timing controller comprises a first end connected to the comparator.

5. The bypass apparatus of claim 4, wherein the timing controller comprises a resistor and a capacitor, and
the preset state maintenance time is determined based on a ratio of resistance of the resistor to capacitance of the capacitor.

6. The bypass apparatus of claim 5, wherein the first switch device comprises a gate terminal connected to a first output terminal of the timing controller, and the second switch device comprises a gate terminal connected to a second output terminal of the timing controller, and
the first output terminal and the second output terminal are different in an output value from each other.

7. A bypass apparatus for controlling power supplied to a chime bell in accordance with operations of a doorbell apparatus, the bypass apparatus comprising:
a first connection terminal and a second connection terminal to which alternating current (AC) power is received from a transformer;
a rectifier that is connected to the first connection terminal and the second connection terminal, and rectifies the AC power into direct current (DC) power to supply operation power;
a current detector for detecting an input current flowing from the first connection terminal to the doorbell apparatus;
a first switch device that is turned on when a current detected in the current detector is lower than a reference current, and is turned off when the detected current is equal to or higher than the reference current; and
a second switch device that is turned off when the detected current is lower than the reference current, and is turned on when the detected current is equal to or higher than the reference current; wherein
the doorbell apparatus, the first connection terminal, the first switch device and the second connection terminal are configured to form a first closed loop when the first switch device is turned on; and
the doorbell apparatus, the chime bell, the first connection terminal, the second switch device, and the second connection terminal are configured to form a second closed loop when the second switch device is turned on.

8. The bypass apparatus of claim 7, further comprising a third connection terminal and a fourth connection terminal that output the AC power to the doorbell apparatus; wherein
the third connection terminal is connected to the first connection terminal,
the fourth connection terminal is connected to a first end of the first switch device and a first end of the second switch device, and
the first switch device comprises a second end connected to the second connection terminal, and the second switch device comprises a second end connected to the second connection terminal.

9. The bypass apparatus of claim 7, further comprising a comparator that compares the detected current and the reference current.

10. The bypass apparatus of claim 9, further comprising a timing controller that is connected to each of the first switch device and the second switch device, generates a control signal for controlling the first switch device and the second switch device, and maintains a turn-off state of the first switch device and a turn-on state of the second switch device for a preset state maintenance time;
wherein the timing controller comprises a first end connected to the comparator.

11. The bypass apparatus of claim 10, wherein the timing controller comprises a resistor and a capacitor, and
the preset state maintenance time is determined based on a ratio of resistance of the resistor to capacitance of the capacitor.

12. The bypass apparatus of claim 11, wherein the first switch device comprises a gate terminal connected to a first output terminal of the timing controller, and the second switch device comprises a gate terminal connected to a second output terminal of the timing controller, and
the first output terminal and the second output terminal are different in an output value from each other.

13. The bypass apparatus of claim 7, wherein operation states of the doorbell apparatus comprises a first state where a doorbell button is pressed, and a second state where the doorbell button is not pressed, and
an input current in the first state is greater than an input current in the second state.

14. A bypass method of controlling power supplied to a chime bell in accordance with operation states of a doorbell apparatus, the bypass method comprising:
detecting a current to detect an input current flowing from a transformer to the doorbell apparatus;
turning on a first switch device and turning off a second switch device when the current detected in the detecting of the current is lower than a reference current, and turning off the first switch device and turning on the second switch device when the current detected in the detecting of the current is equal to or higher than the reference current;
forming a first closed loop with the transformer, the doorbell apparatus, and the first switch device when the first switch device is turned on; and
forming a second closed loop with the transformer, the doorbell apparatus, the chime bell, and the second switch device when the second switch device is turned on.

15. The bypass method of claim 14, wherein
the input current flows to the doorbell apparatus without passing through the chime bell when the first closed loop is formed, and
the input current flows to the doorbell apparatus after passing through the chime bell when the second closed loop is formed.

16. The bypass method of claim 14, further comprising, by a timing controller, generating a control signal for controlling the first switch device to be turned on or off and the second switch device to be turned on or off in accordance with results of comparison between the detected current and the reference current.

17. The bypass method of claim 16, wherein the timing controller sets in advance a time, for which a turn-off state of the first switch device is maintained and a turn-on state of the second switch device is maintained.
